(19) United States
(12) Patent Application Publication
(10) Pub. No.: US 2020/0065654 A1
(43) Pub. Date: Feb. 27, 2020

(54) NEURAL NETWORK FUSION APPARATUS AND MODULAR NEURAL NETWORK FUSION METHOD AND MATCHING INTERFACE GENERATION METHOD FOR THE SAME

(71) Applicant: Electronics and Telecommunications Research Institute, Daejeon (KR)

(72) Inventor: Kyung Hee LEE, Daejeon (KR)

(73) Assignee: Electronics and Telecommunications Research Institute, Daejeon (KR)

(21) Appl. No.: 16/535,709

(22) Filed: Aug. 8, 2019

(30) Foreign Application Priority Data
Aug. 22, 2018 (KR) 10-2018-0097902
May 21, 2019 (KR) 10-2019-0059605

(51) Int. Cl. G06N 3/04; G06K 9/62; G10L 15/16

(52) U.S. Cl. CPC G06N 3/0454; G10L 15/16; G06K 9/6288

(57) ABSTRACT

Disclosed herein are a neural network fusion apparatus and a modular neural network fusion method and a matching interface generation method of the neural network fusion apparatus. The modular neural network fusion method in a neural network fusion apparatus includes collecting meta-information of a first neural network and a second neural network, connecting a matching module between the first neural network and the second neural network using the collected meta-information so that output data of the first neural network matches input data of the second neural network, and executing a neural network interworking service for obtaining output data of the second neural network from input data of the first neural network through the first and second neural networks connected to each other via the matching module.

### CROSS REFERENCE TO RELATED APPLICATIONS

This application claims the benefit of Korean Patent Application Nos. 10-2018-0097902, filed Aug. 22, 2018 and 10-2019-0059605, filed May 21, 2019, which are hereby incorporated by reference in their entirety into this application.

### BACKGROUND OF THE INVENTION

### 1. Technical Field

The present invention relates to a neural network fusion apparatus and to a modular neural network fusion method and a matching interface generation method for the neural network fusion apparatus.

### 2. Description of the Related Art

Generally, the human brain's neural network is connected to neurons, each including dendrites, a soma, an axon, etc., and to synapses for coupling the neurons. These neurons, synapses, etc. are connected over networks corresponding to multiple layers, and are configured to transfer electrical signals, thus enabling the brain to operate. With the development of computer technology, an artificial neural network that is operating by simulating the operations of neurons and synapses of the human brain's neural network has appeared. Such an artificial neural network has base structures for assigning weights to respective inter-neuron connections, such as synapses, and processing weighted inputs to generate output signals, and a structure of connecting the base structures in the form of a network. For an artificial-intelligence service, the neural network may be reconstructed in the form of networks corresponding to multiple layers, and thus an intelligent service is provided by assigning weights to operation functions of respective neurons and inter-neuron connection signals. That is, a single function for inference, determination, recognition, etc. is defined, and the hierarchical structure and connection structure of the neural network for the single function are decided on, after which a complete single operable neural network is configured by adjusting inter-neuron connection weights through various types of learning algorithms An artificial neural network is characterized in that a neural network for each function is configured and a process for training the neural network and making inferences pertaining to the corresponding neural network is performed. Therefore, for a new service for fusing functions of existing neural networks, a new neural-network architecture must be established and a connection network architecture must be reestablished through training.

### SUMMARY OF THE INVENTION

Accordingly, the present invention has been made keeping in mind the above problems occurring in the prior art, and an object of the present invention is to provide a neural network fusion apparatus in which existing neural networks for performing unit functions required in a new artificial-intelligence service are present and are combined to configure an artificial-intelligence service, and a modular neural network fusion method and a matching interface generation method for the neural network fusion apparatus.

Another object of the present invention is to provide a neural network fusion apparatus that helps facilitate the development of an artificial-intelligence service and the reduction of the development period for the artificial-intelligence service, etc., and a modular neural network fusion method and a matching interface generation method for the neural network fusion apparatus.

A further object of the present invention is to provide a neural network fusion apparatus that fuses artificial-intelligence neural networks for performing unit functions and allows the artificial-intelligence neural networks to interoperate, and a modular neural network fusion method and a matching interface generation method for the neural network fusion apparatus.

Yet another object of the present invention is to provide a neural network fusion apparatus that facilitates the optimal partial learning and reprocessing of modular neural networks and also facilitates the development of integration and fusion services for modular neural networks, and a modular neural network fusion method and a matching interface generation method for the neural network fusion apparatus.

Objects of the present invention are not limited to the above-described objects, and other objects, not described here, will be clearly understood by those skilled in the art from the following descriptions.

In accordance with an aspect of the present invention to accomplish the above objects, there is provided a modular neural network fusion method for a neural network fusion apparatus, including collecting meta-information of a first neural network and a second neural network; connecting a matching module between the first neural network and the second neural network using the collected meta-information so that output data of the first neural network matches input data of the second neural network; and executing a neural network interworking service for obtaining output data of the second neural network from input data of the first neural network through the first and second neural networks connected to each other via the matching module.

The collecting the meta-information may include reading information about a data type and format information of an output parameter from a meta-information storage of the first neural network; and reading information about a data type and format information of an input parameter from a meta-information storage of the second neural network.

The connecting the matching module may include generating, by a matching interface generator, a matching interface corresponding to output parameters of the first neural network and input parameters of the second neural network.

The matching interface may include plurality of transform plugins, and connecting the matching module may further include generating the plurality of transform plugins; and connecting the plurality of transform plugins to each other.

The matching interface generator may determine whether generation of a matching interface is impossible.

The executing the neural network interworking service may include generating respective input interfaces and output interfaces of the first and second neural networks.

The executing the neural network interworking service may further include connecting the output interface of the first neural network to the matching interface; and connecting the matching interface to the input interface of the second neural network.

The executing the neural network interworking service may further include setting activation functions contained in the input interfaces and the output interfaces of the first and second neural networks.

The first neural network may be a speech recognition neural network, and the second neural network may be an image recognition neural network.

In accordance with another aspect of the present invention to accomplish the above objects, there is provided a method for generating a matching interface connecting a first neural network and a second neural network for a neural network fusion apparatus, including initializing an input format of the first neural network and an output format of the second neural network; determining whether the first neural network and the second neural network are capable of being connected to each other without requiring transform plugins by comparing the input format with the output format; upon determining that the first neural network and the second neural network are not capable of being connected to each other without requiring transform plugins, determining whether there are matchable transform plugins respectively corresponding to the input format and the output format; and upon determining that there are matchable transform plugins, generating a matching interface for connecting the first neural network to the second neural network by combining the matchable transform plugins.

The initializing the input format of the first neural network and the output format of the second neural network may include storing, as the input format, a data type of an output parameter stored in a meta-information storage of the first neural network; and storing, as the output format, a data type of an input parameter stored in a meta-information storage of the second neural network.

The initializing the input format of the first neural network and the output format of the second neural network may further include storing, as the input format, a data format of reference information stored in the meta-information storage of the first neural network; and storing, as the output format, a data format of reference information stored in the meta-information storage of the second neural network.

The determining whether the first neural network and the second neural network are capable of being connected to each other may include determining whether the data type of the output parameter and the data type of the input parameter are identical to each other by comparing the data types with each other.

The determining whether there are matchable transform plugins may include searching for transform plugins having a data type identical to that of the input format and the output format.

The generating the matching interface may include storing first transform plugins having a data type identical to that of the input format; and storing second transform plugins having a data type identical to that of the output format.

The generating the matching interface may further include generating a matchable combination by comparing elements of the input format with respective elements of the output format.

The generating the matching interface may further include determining whether the first transform plugins and the second transform plugins are capable of being combined with each other.

In accordance with a further aspect of the present invention to accomplish the above objects, there is provided a neural network fusion apparatus, including at least one processor; and a memory for storing at least one instruction that is executed by the at least one processor, wherein the at least one instruction is executed by the at least one processor so that a first neural network is generated by a modular neural network module, a second neural network is generated by the modular neural network module, and output data of the first neural network matches input data of the second neural network through a matching interface.

The first neural network may receive image data and output a text file, and the second neural network may receive the text file and output an audio file.

The first neural network may be a speech recognition neural network, the second neural network may be an image recognition neural network, and the first neural network and the second neural network may be fused through the matching interface, thus enabling a context-aware neural network to be implemented.

### BRIEF DESCRIPTION OF THE DRAWINGS

The accompanying drawings are provided to help the understanding of the present embodiments and the embodiments are provided together with the detailed descriptions thereof. However, the technical features of the present embodiments are not limited to specific drawings, and the features disclosed in respective drawings may be combined to configure new embodiments.

FIG. 1 is a diagram exemplarily illustrating a neural network fusion apparatus according to an embodiment of the present invention;

FIG. 2 is a diagram exemplarily illustrating a modular neural network module according to an embodiment of the present invention;

FIG. 3A is a diagram exemplarily illustrating a first neural network, FIG. 3B is a diagram exemplarily illustrating a second neural network, and FIG. 3C is a diagram exemplarily illustrating an artificial-intelligence service for combining the first neural network with the second neural network;

FIG. 4 is a diagram exemplarily illustrating an application service provided through parallel and sequential connections of neural networks according to an embodiment of the present invention;

FIG. 5 is a diagram exemplarily illustrating information stored in neural-network architecture information storage according to an embodiment of the present invention;

FIG. 6 is a diagram exemplarily illustrating local data storage according to an embodiment of the present invention;

FIG. 7 is a diagram exemplarily illustrating an input interface (I/F) according to an embodiment of the present invention;

FIG. 8 is a diagram exemplarily illustrating the operation of an activation function according to an embodiment of the present invention;

FIG. 9 is a diagram exemplarily illustrating information stored in the local data storage according to an embodiment of the present invention;

FIG. 10 is a diagram exemplarily illustrating the data types of parameters represented in meta-information storage according to an embodiment of the present invention;

FIG. 11 is a diagram exemplarily illustrating a matching interface (I/F) according to an embodiment of the present invention;

FIG. 12 is a diagram exemplarily illustrating a transform plugin according to an embodiment of the present invention;

FIG. 13 is a diagram exemplarily illustrating a matching I/F generator according to an embodiment of the present invention;

FIG. 14 is a flowchart exemplarily illustrating the operation of the matching I/F generator according to an embodiment of the present invention;

FIG. 15A is a diagram illustrating an example in which neural networks are directly connected to each other without requiring transform plugins according to an embodiment, FIG. 15B is a diagram illustrating an example in which neural networks are connected to each other when a single transform plugin is used as a matching I/F, and FIG. 15C is a diagram illustrating an example in which neural networks are connected to each other when a matching I/F in which plurality of transform plugins are combined with each other is used;

FIG. 16 is a flowchart exemplarily illustrating a modular neural network fusion process for the neural network fusion apparatus according to an embodiment of the present invention; and

FIG. 17 is a diagram exemplarily illustrating an electronic device according to an embodiment of the present invention.

### DESCRIPTION OF THE PREFERRED EMBODIMENTS

Embodiments of the present invention are described with reference to the accompanying drawings in order to describe the present invention in detail so that those having ordinary knowledge in the technical field to which the present invention pertains can easily practice the present invention.

Reference will now be made in detail to various embodiments of the present invention, specific examples of which are illustrated in the accompanying drawings and described below, since the embodiments of the present invention can be variously modified in many different forms. However, this is not intended to limit the present invention to particular modes of practice, and it is to be appreciated that all changes, equivalents, and substitutes that do not depart from the spirit and technical scope of the present invention are encompassed in the present invention. It will be understood that, although the terms “first” and “second” may be used herein to describe various elements, these elements should not be limited by these terms. These terms are only used to distinguish one element from another element. For instance, a first element discussed below could be termed a second element without departing from the teachings of the present invention. Similarly, the second element could also be termed the first element. It will be understood that when an element is referred to as being “coupled” or “connected” to another element, it can be directly coupled or connected to the other element, or intervening elements may be present therebetween. In contrast, it should be understood that when an element is referred to as being “directly coupled” or “directly connected” to another element, there are no intervening elements present.

The terminology used herein is for the purpose of describing particular embodiments only and is not intended to be limiting. In the present invention, the singular forms are intended to include the plural forms as well, unless the context clearly indicates otherwise. It should be further understood that the terms “comprise”, “include”, and “have”, when used in this specification, specify the presence of stated features, integers, steps, operations, elements, components, and/or combinations thereof, but do not preclude the presence or addition of one or more other features, integers, steps, operations, elements, components, and/or combinations thereof. Unless differently defined, all terms used here including technical or scientific terms have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitely defined in the present specification.

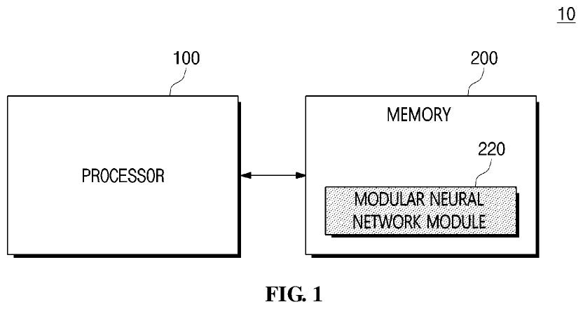

FIG. 1 is a diagram exemplarily illustrating a neural network fusion apparatus 10 according to an embodiment of the present invention. Referring to FIG. 1, the neural network fusion apparatus 10 may include a processor 100 and memory 200.

The processor 100 may perform interwork between neural network modules by executing instructions stored in the memory 200.

The memory 200 may store a modular neural 220. The modular neural network module 220 may include modular neural networks (or shared neural networks) that facilitate the fusion/interoperation of artificial-intelligence neural networks in order to provide an artificial-intelligence service.

Each neural network may be an artificial neural network which performs a unit function. In an embodiment, the artificial neural network may be configured as code executable using a computer program such as Tensorflow, Caffe, Theano or the like. In another embodiment, the artificial neural network may be described as a combination of a descriptive language, such as a Neural Network Exchange Format (NNEF), and an engine which can execute the descriptive language.

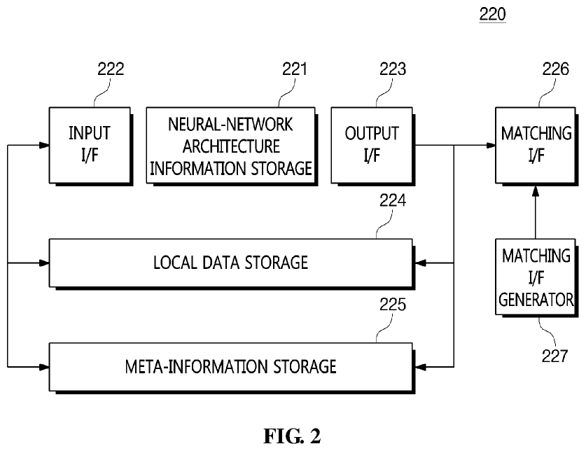

FIG. 2 is a diagram exemplarily illustrating a modular neural network module 220 according to an embodiment of the present invention. Referring to FIG. 2, the modular neural network module 220 may include neural-network architecture information storage 221, an input interface (I/F) 222, an output I/F 223, local data storage 224, meta-information storage 225, a matching I/F 226, and a matching I/F generator 227.

The neural-network architecture information storage 221, which is a device for storing neural networks, may store nodes, layers, operation functions, etc., which constitute an artificial neural network. The input I/F 222 is an interface functioning as a buffer which temporally stores data that is input to a modular neural network. The output I/F 223 is a buffer-type interface which stores the output of the modular neural network. The local data storage 224 may be a device for storing data required for the operation of the neural network in a device outside the neural network. In an embodiment, when the size of data required for the execution of the neural network is small, the required data may be stored in a neural network storage format. In another embodiment, when the size of data required for the execution of the neural network is large, the required data may be stored in an external storage device rather than in the neural network format. The meta-information storage 225, which is a device for storing the functions of the modular neural network, operation-related constraints, etc., may store information, such as the name, input data, and output data of each neural network.

When neural networks are sequentially connected to each other, the matching I/F 226 may perform functions required in order to connect the output of one neural network to the input of another neural network. The matching I/F generator 227 is a device for enabling the matching I/F 226 to be easily generated. In an embodiment, the matching I/F generator 227 may generate the matching I/F 226 required in order to match the inputs and outputs of individual neural networks with each other by storing transform plugins for supporting the conversion of the format of media and by connecting required transform plugins to each other.

As illustrated in FIG. 2, an artificial neural network which executes a unit function may be configured to allow neural networks to interoperate (i.e. interwork). For this, the neural-network architecture information storage 221, which stores neural network code, and a local data storage 224, which stores local reference data that is used during the operation of the modular neural network, may be generated. Also, for neural network interoperation, information about the input I/F 222, which is an input-side buffer, information about the output I/F 223, which is an output-side buffer, and information such as the functions, input format and input parameters, and output format and output parameters of the modular neural network may be stored in the meta-information storage 225.

As described above, when a base structure for neural network interoperation, that is, the modular neural network module 220, is prepared, a neural network may be connected to a stage prior to or subsequent to the modular neural network module 220 for the purpose of neural network interoperation. In this case, an input interface and an output interface may be different from each other. By attaching the matching I/F 226 for different input/output interfaces, the neural networks may interoperate. A user analyzes the meta-information storage 225 of each modular neural network through the matching I/F generator 227, and thus the matching I/F 226 may be generated. Here, the matching I/F 226 may be generated by combining matching plugins so that an input and an output interoperate with each other.

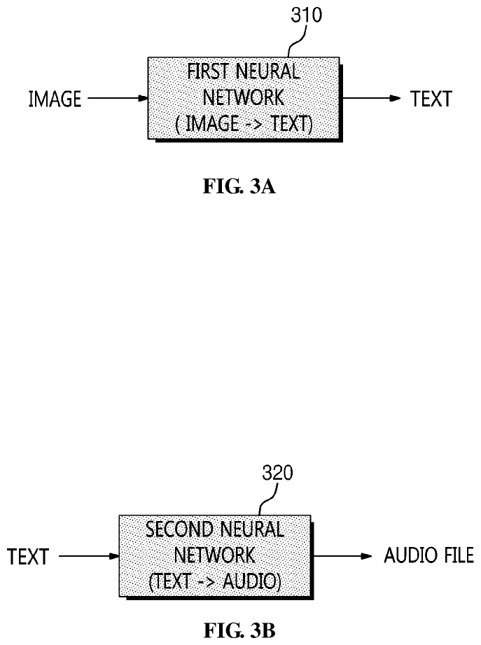

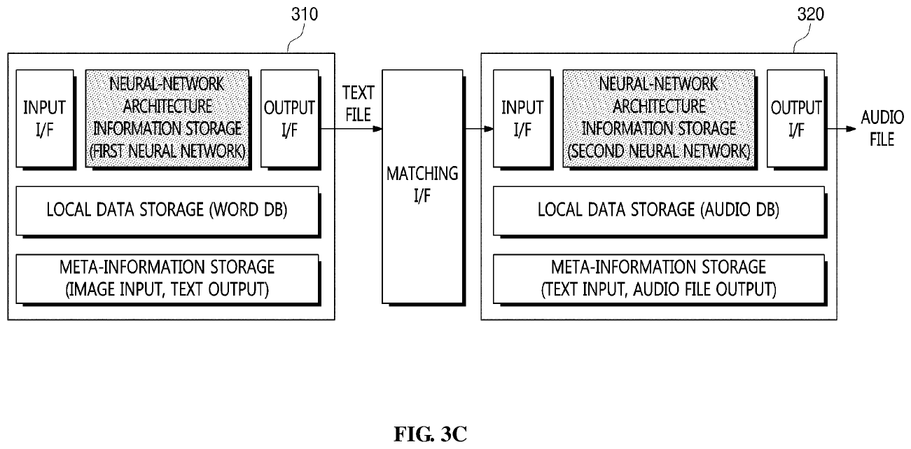

FIGS. 3A, 3B and 3C are diagrams illustrating embodiments in which a first neural network 310 and a second neural network 320 are sequentially connected to each other.

FIG. 3A is a diagram exemplarily illustrating the first neural network 310. Referring to FIG. 3A, the first neural network 310 may receive an image and then output the image in the form of text. The first neural network 310 may include the number of inputs, a weight, a neural network function, a bias, the number of outputs, etc.

FIG. 3B is a diagram exemplarily illustrating the second neural network 320. Referring to FIG. 3B, the second neural network 320 may receive text and then output an audio file imparted with emotion. The second neural network 320 may include the number of inputs, a weight, a neural network function, a bias, and the number of outputs. In an embodiment, the audio file may be a wave file. However, it should be understood that the audio file of the present invention is not limited to such a wave file.

FIG. 3C is a diagram exemplarily illustrating an artificial-intelligence service in which the first neural network 310, which recognizes an image and then outputs text that explains the situation (context) of objects in the image, and a second neural network 320, which converts the text output from the first neural network 310 into audio and outputs the audio, are combined with each other. Referring to FIG. 3C, there can be provided an artificial-intelligence service that outputs the description of the image while controlling the intonation of the audio in conformity with context or changing the volume of the audio depending on the context by combining the first neural network 310 with the second neural network 320 through a matching I/F (or a matching module).

In an embodiment, the first neural network 310 may include local data storage having a word database (DB) and meta-information storage for outputting high definition (HD) 24-bit color input text. However, it should be understood that the present invention is not limited thereto.

In an embodiment, the second neural network 320 may include local data storage having an audio DB and meta-information storage for receiving text and outputting an 8 kHz mono wave file. However, it should be understood that the present invention is not limited thereto.

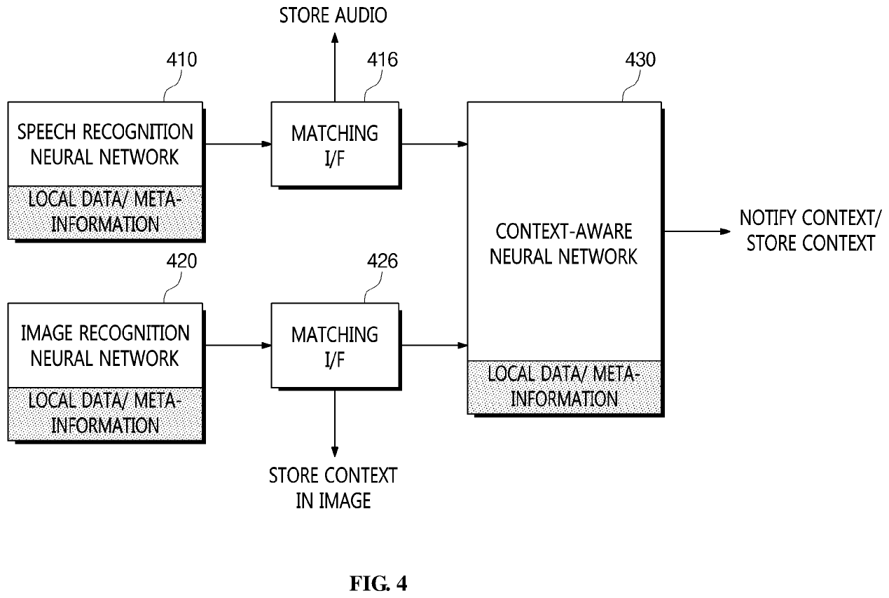

FIG. 4 is a diagram exemplarily illustrating an application service provided through parallel and sequential connections of neural networks according to an embodiment of the present invention.

A speech recognition neural network 410 may receive an audio signal and then output text corresponding to the received audio signal. An image recognition neural network 420 may receive an image signal and then identify an object in the image and recognize the location of the object. A context-aware neural network 430, which is aware of the context of the environment in which an image and audio appear based on the audio signal and the image signal, may be implemented by combining the speech recognition neural network 410 with the image recognition neural network 420.

In an embodiment, at the same time that respective results of recognition by the speech recognition neural network 410 and the image recognition neural network 420 are transmitted, as input signals, to the context-aware neural network 430, the results may be stored as separate files. For example, the results of recognition by the speech recognition neural network 410 may be stored in the form of audio-based text via a matching interface (I/F) 416. The results of recognition by the image recognition neural network 420 may be stored in the form of text related to context in the image via a matching I/F 426.

The context-aware neural network 430 may construct a context-aware service based on the results of recognition by the speech and image recognition neural networks. For example, the context-aware neural network 430 may provide notification of context or store information about the context in the form of text.

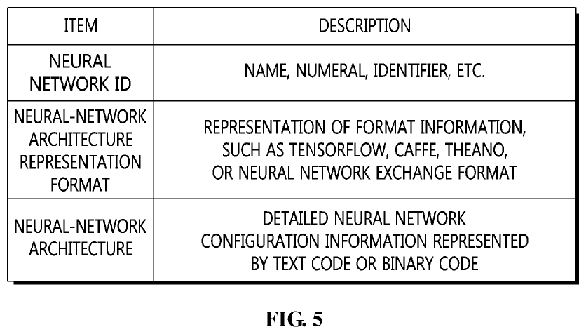

FIG. 5 is a diagram exemplarily illustrating information stored in neural-network architecture information storage 221 according to an embodiment of the present invention. Referring to FIG. 5, the neural-network architecture information storage 221 may store the ID (i.e., name or identifier) of a modular neural network, a neural-network architecture representation format, and a neural-network architecture. Here, the neural-network architecture representation format may include Tensorflow, Caffe, Theano, Neural Network Exchange Format (NNEF), etc.

In an embodiment, the neural-network architecture may include detailed neural network configuration information represented by text code or binary code.

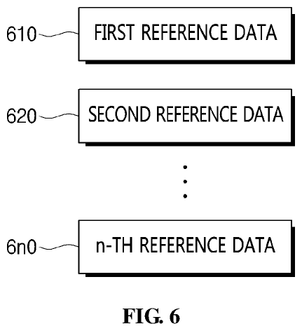

FIG. 6 is a diagram exemplarily illustrating local data storage 224 according to an embodiment of the present invention. Referring to FIG. 6, the local data storage 224 stores pieces of reference data 610, 620, . . . , 6n0 (where n is an integer of 2 or more) required for the operation of a neural network. The format of data that is stored is not particularly limited. For example, the local data may be binary data, text, a Uniform Resource Locator (URL), or the like.

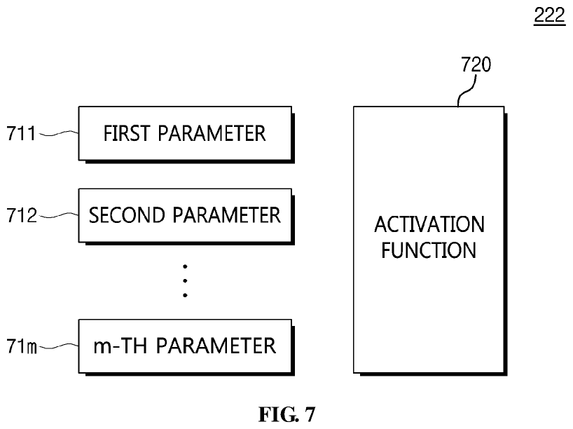

FIG. 7 is a diagram exemplarily illustrating an input I/F 222 according to an embodiment of the present invention. Referring to FIG. 7, the input I/F 222 may include multiple parameters 711, 712, . . . , 71m (where m is a natural number) and an activation function 720.

The input I/F 222, which is a device for synchronizing the inputs and outputs of neural networks that are connected to stages previous and subsequent to a neural network, is a buffer connected to an input end. The input I/F 222 may include no parameter or may include one or more parameters.

The activation function 720 may control the output time of the buffer so as to synchronize the operations of the entire service.

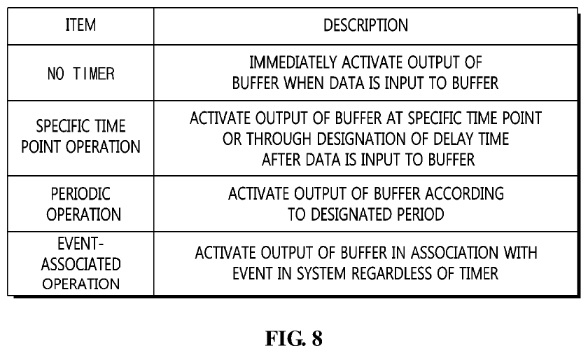

FIG. 8 is a diagram exemplarily illustrating the operation of the activation function 720 according to an embodiment of the present invention.

In an embodiment, when data arrives at a buffer, the activation function 720 may immediately output the data without requiring a special synchronization mechanism (no timer).

In an embodiment, the activation function 720 may activate, using a timer, the output of the buffer depending on a given time/time point (specific time point operation) or a specific time interval (periodic operation).

In an embodiment, the activation function 720 may activate the output of the buffer in synchronization with a specific event (event-associated operation) in a system including a service or a neural network, regardless of the timer.

Meanwhile, the output I/F 223, which is a device for synchronizing the inputs and outputs of the neural networks that are connected to the stages previous and subsequent to the neural network, is a buffer connected to an output end. The output I/F 223 may include one or more parameters. The output I/F 223 may include an activation function for controlling the output time of the buffer to synchronize the operations of the entire service. The structure of the output I/F 223 may be identical or similar to that of the input I/F 222.

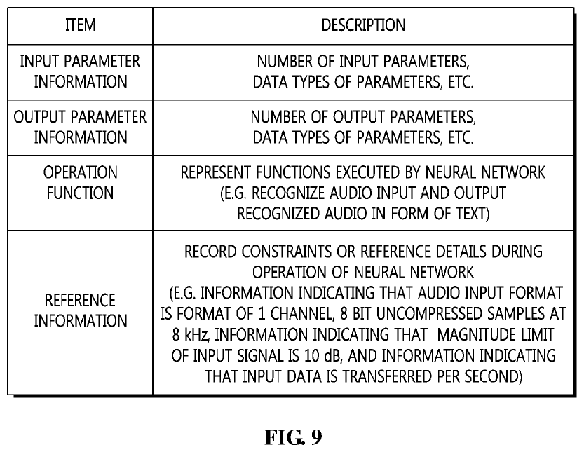

FIG. 9 is a diagram exemplarily illustrating information stored in local data storage 224 according to an embodiment of the present invention. Referring to FIG. 9, the local data storage 224 may store input parameter information, output parameter information, operation function information, reference information, etc.

In an embodiment, the input parameter information may include the number of input parameters, the data types of the parameters, etc.

In an embodiment, the output parameter information may include the number of output parameters, the data types of the parameters, etc.

In an embodiment, the operation function information may include information representing functions executed by the neural network. For example, the information may be information about a function of recognizing audio input and outputting the recognized audio in the form of text.

In an embodiment, the reference information may include records of constraints or reference details during the operation of the neural network. For example, the reference information may include information indicating that an audio input format is a format of 1 channel, 8 bit uncompressed samples at 8 kHz, information indicating that the magnitude limit of an input signal is 10 dB, information indicating that input data is transferred per second, etc.

Meanwhile, the meta-information storage 225 may store the function of the neural network, the format of input/output parameters, information related to the operation of the neural network, etc.

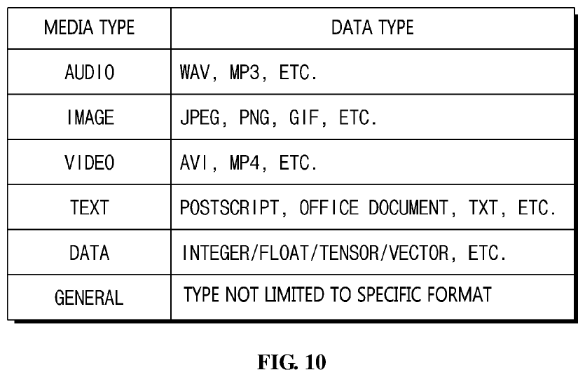

FIG. 10 is a diagram exemplarily illustrating the data types of parameters represented in meta-information storage 225 according to an embodiment of the present invention. Referring to FIG. 10, media types of parameters may include Audio, Image, Video, Text, Data, and General Types.

In an embodiment, the data type of “Audio” may include WAV, MP3, etc.

In an embodiment, the data type of “Image” may include JPEG, PNG, GIF, etc.

In an embodiment, the data type of “Video” may include AVI, MP4, etc.

In an embodiment, the data type of “Text” may include PostScript, Office document, TXT, etc.

In an embodiment, data types of “Data” may include Integer, Float, Tensor, Vector, etc.

In an embodiment, the data type of “General” may include a type that is not limited to a specific format.

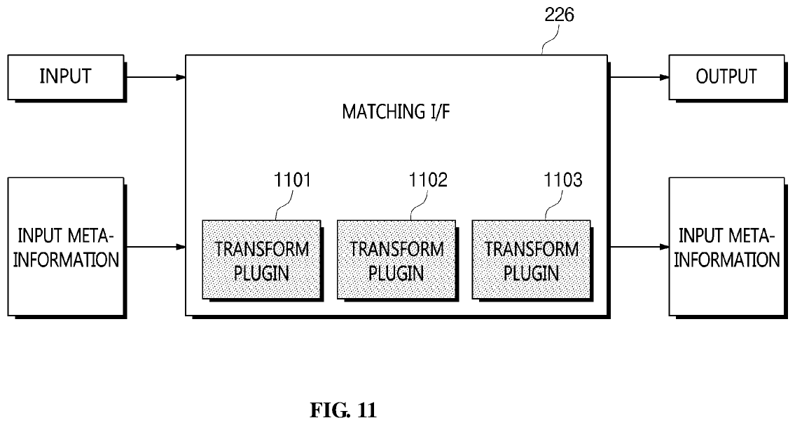

FIG. 11 is a diagram exemplarily illustrating a matching interface (I/F) 226 according to an embodiment of the present invention. Referring to FIG. 11, the matching I/F 226, which is a device for connecting transform plugins to each other and processing and outputting input data, may receive a single input or multiple inputs and copy input data or perform a given function, thus enabling the data to be processed, transformed and output.

In an embodiment, the matching I/F 226 may control a plurality of transform plugins 1101, 1102, and 1103 so that an input becomes an output having a desired format by connecting the transform plugins 1101, 1102, and 1103 in series or in parallel to each other. Although the number of transform plugins illustrated in FIG. 11 is 3, it should be understood that the present invention is not limited thereto.

In an embodiment, information that is initially input to the matching I/F 226 may be connected to a transform plugin connected to a front end in the matching I/F 226. In an embodiment, the output of the last connected transform plugin may be the final output of the matching I/F 226.

Meanwhile, the transform plugins 1101, 1102, and 1103 may be included in the matching I/F 226, and may be devices for actually converting the format of input/output data between neural networks.

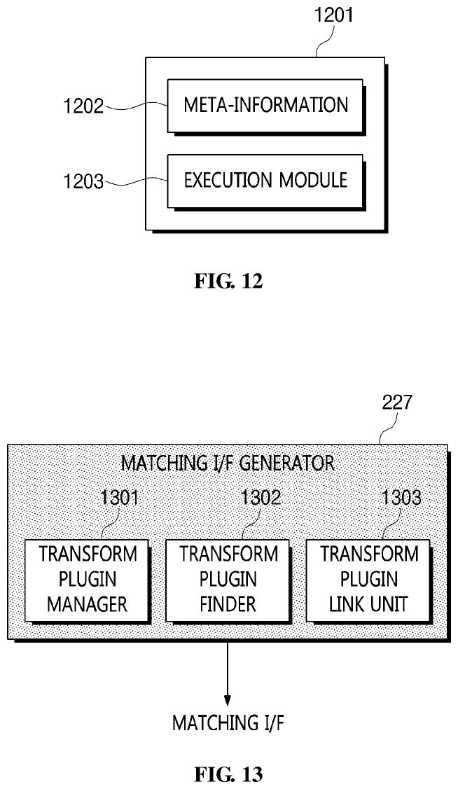

FIG. 12 is a diagram exemplarily illustrating a transform plugin 1201 according to an embodiment of the present invention. Referring to FIG. 12, the transform plugin 1201 may include metadata (meta-information) 1202 for representing input and output formats and functions to be executed and an execution module 1203.

The meta-information 1202 may include input format information, output format information, operation function information, and reference information. In an embodiment, the input format information may include the data types of parameters. In an embodiment, the output format information may include the data types of parameters. In an embodiment, the operation function information may include information specifying the functions of the transform plugin. In another embodiment, the operation function information may be optionally omitted. In an embodiment, the reference information may include information about constraints or reference details during the operation of the transform plugin. In another embodiment, the reference information may be optionally omitted.

The execution module 1203 may include an operation module in which the transform plugin actually executes functions.

Meanwhile, the matching I/F generator 227 may be a device for generating the matching I/F 226 for connecting a required input end to an output end during the connection neural networks. Such a matching I/F generator 227 may collect input/output-related information of neural networks requiring interoperation from meta-information storage, and may perform a matching function such as format conversion so that the parameter of a neural network, the output of which is desired to be used as the input of an additional neural network, among interoperating neural networks, is associated with the input parameter of the neural network to be connected to the corresponding neural network.

FIG. 13 is a diagram exemplarily illustrating the matching I/F generator 227 according to an embodiment of the present invention. Referring to FIG. 13, the matching I/F generator 227 may include a transform plugin manager 1301, a transform plugin finder 1302, and a transform plugin link unit 1303.

The transform plugin manager 1301 may perform a management function such as registration or deletion so that transform plugins for performing a function such as data format conversion can be used by the matching I/F 226. At this time, each of the transform plugins may register its own input/output data types and format information together.

The transform plugin finder 1302 may perform a function of searching transform plugins registered in the transform plugin manager 1301 for transform plugins that are usable for parameter association based on the meta-information of each neural network.

The transform plugin link unit 1303 may perform a function of generating the matching I/F 226 by connecting and combining transform plugins found as a result of the search by the transform plugin finder 1302 so that the inputs and outputs of the connected neural networks can interoperate each other. The transform plugin link unit 1303 may finally generate the matching I/F 226 by receiving linkable transform plugins and combining the transform plugins in an interoperable form.

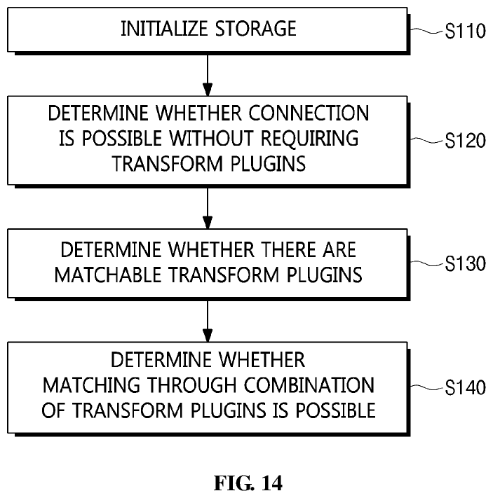

FIG. 14 is a flowchart exemplarily illustrating the operation of the matching I/F generator 227 according to an embodiment of the present invention. Referring to FIGS. 1 to 14, the operation of the matching I/F generator 227 may be performed as follows.

Storage for each neural network may be initialized at step S110. In an embodiment, the data type information of an output parameter and the data format information of reference information that are stored in the meta-information storage 225 of a first neural network may be recorded as an input format in first neural-network architecture information storage. In an embodiment, the data type information of an input parameter and data format information of reference information that are stored in the meta-information storage of a second neural network may be recorded as an output format in second neural-network architecture information storage.

Thereafter, whether the connection of neural networks is possible without requiring transform plugins may be determined by comparing the input format with the output format at step S120. For example, whether the data types and formats of the input format and the output format are identical to each other may be determined. If it is determined that the data types and formats of the input format and the output format are identical to each other, the neural networks may be directly connected without requiring transform plugins. In this case, information indicating that the neural networks can be connected without requiring transform plugins may be returned, and the matching I/F generation operation may be terminated.

In contrast, if it is determined that the connection of neural networks is impossible without requiring plugins, whether there are matchable transform plugins may be determined at step S130. In an embodiment, whether there are transform plugins having the data types and formats identical to those of the input format and the output format may be determined. If it is determined that there are transform plugins having data types and formats identical to those of the input format and the output format, the found transform plugins may be returned, and the matching I/F generation operation may be terminated.

Thereafter, whether matching between the neural networks through the combination of the found transform plugins is possible may be determined at step S140. In an embodiment, a set of transform plugins that support the same input data type and format as the input format may be searched for, and the found set may be stored as an input candidate. In an embodiment, a set of transform plugins that support the same output data type and format as the output format may be searched for, and the found set may be stored as an output candidate.

In an embodiment, elements of the input format are compared with respective elements of the output format, and matchable combinations may be generated as a result of the comparison. When there are elements of the input format and elements of the output format that may be combined with each other, the found elements of the input format may be connected to the elements of the output format that can be combined with the found elements of the input format. The results of the matching may be returned, and the matching I/F generation operation may be terminated.

In an embodiment, a set of transform plugins that are not included in the input candidate and the output candidate may be stored in a pool. Combinations of the elements of the input candidate and the elements of the output candidate may be calculated, and the elements of the pool for each combination may be repeatedly searched for. Thus, the outputs of elements of the input candidate may be received, and combinations that can connect the outputs to the inputs of the elements of the output candidate may be configured from the elements in the pool.

In an embodiment, when transform plugins that can be combined with each other are found in the results of the search procedure, the combined transform plugins may be returned, and then the matching I/F generation operation may be terminated. When the search procedure fails, notification of failure thereof may be provided, and the matching I/F generation operation may be terminated.

Meanwhile, in the neural network fusion operation, the case where a direct connection is possible, the case where a single transform plugin is used, and the case where a plurality of transform plugins are connected may be implemented.

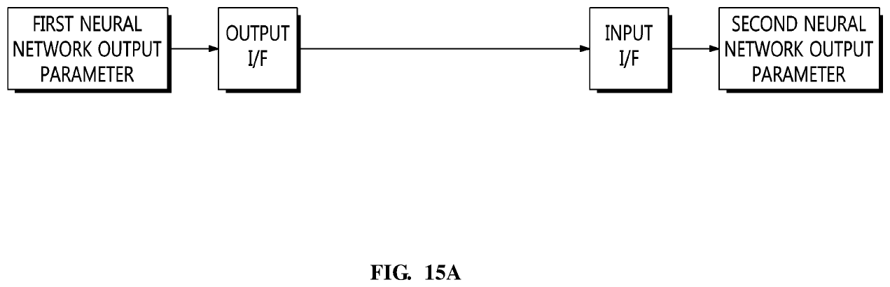

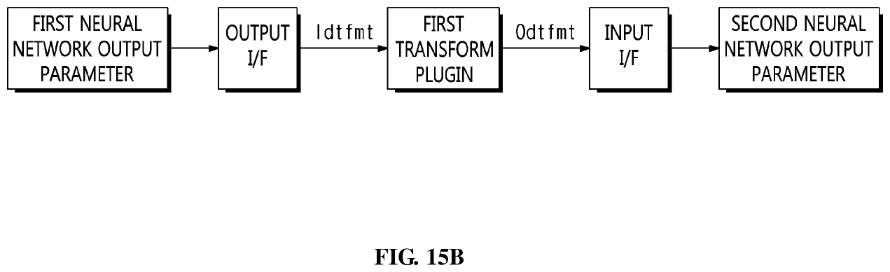

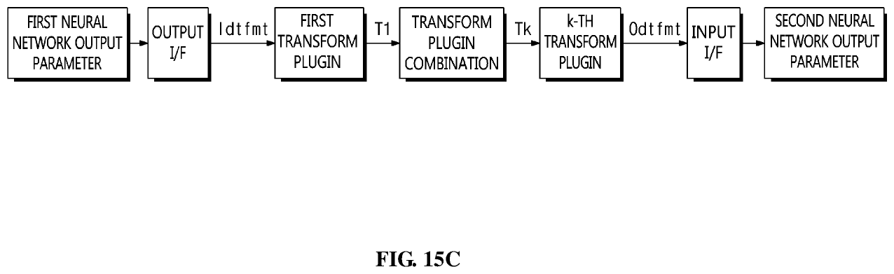

FIGS. 15A, 15B, and 15C are diagrams illustrating embodiments related to the connection of transform plugins.

FIG. 15A is a diagram illustrating an embodiment in which neural networks are directly coupled to each other without requiring transform plugins.

FIG. 15B is a diagram illustrating an embodiment in which neural networks are connected to each other when a single transform plugin is used as the matching I/F 226. The data type and format information of the output parameter of a first neural network (leading neural network) correspond to Idtfmt and the data type and format information of the input parameter of a second neural network (subsequent neural network) correspond to Odtfmt.

FIG. 15C is a diagram illustrating an embodiment in which neural networks are connected to each other when the matching I/F 226 in which plurality of transform plugins are combined with each other is used. The data type and format information of the output parameter of a first neural network (leading neural network) correspond to Idtfmt, and the data type and format information of the input parameter of a second neural network (subsequent neural network) correspond to Odtfmt. An arbitrary data type and format may be T1, T2, Tk. Here, k is an integer of 2 or more.

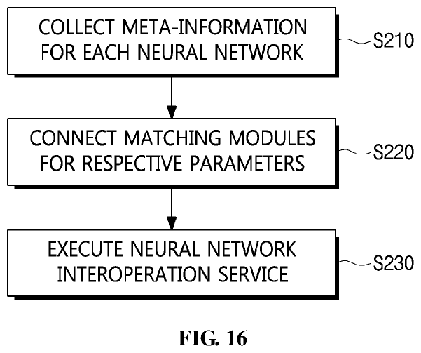

FIG. 16 is a flowchart exemplarily illustrating a modular neural network fusion process for the neural network fusion apparatus 10 according to an embodiment of the present invention. Referring to FIGS. 1 to 16, the modular neural network fusion process may be performed as follows. Below, a procedure required in order to create a new artificial-intelligence service by combining modular neural networks will be described based on the above-described devices.

Meta-information of each neural network may be collected at step S210. For example, meta-information of a first neural network and meta-information of a second neural network may be collected. In an embodiment, the data type information of an output parameter and format information of reference information stored in the meta-information storage of the first neural network (or leading neural network) may be read. In an embodiment, the data type information of an input parameter and format information of reference information stored in the meta-information storage of the second neural network (or subsequent neural network) may be read.

Thereafter, matching I/Fs (modules) for respective parameters may be connected to each other using the collected meta-information so that the output data of the first neural network matches the input data of the second neural network at step S220. In an embodiment, matching I/Fs (226, see FIG. 2) may be generated for respective output parameters of the first neural network and for respective input parameters of the second neural network through a matching I/F generator (227, see FIG. 2). In an embodiment, when a matching I/F 226 cannot be generated, information indicating that generation of a matching I/F is impossible may be returned, after which the process may be terminated. In an embodiment, when multiple matching I/Fs are generated, the generated I/Fs may be connected to each other.

Through the first and second neural networks connected via the matching modules, a neural network interworking service for obtaining the output data of the second neural network from the input data of the first neural network may be executed at step S230.

In an embodiment, the matching interface (I/F) generator may generate a matching I/F corresponding to the output parameters of the first neural network and the input parameters of the second neural network. In an embodiment, the matching I/F may include plurality of transform plugins. In an embodiment, the generation of the matching interface may include the generation of plurality of transform plugins and the connection of the plurality of transform plugins.

In an embodiment, the matching I/F generator may determine whether the generation of a matching I/F is impossible.

In an embodiment, the execution of the neural network interworking service may include the generation of respective input interfaces and output interfaces of the first and second neural networks. In an embodiment, the execution of the neural network interworking service may include the connection of the output interface of the first neural network to a matching interface and the connection of the matching interface to the output interface of the second neural network.

In an embodiment, the execution of the neural network interworking service may include the setting of activation functions contained in the input interfaces and output interfaces of the first and second neural networks. In an embodiment, the first neural network may be a speech recognition neural network, and the second neural network may be an image recognition neural network.

In accordance with the present invention, when a new artificial-intelligence service is implemented, the functions of modular neural networks, in which existing unit functions are configured, may be utilized. The present invention may provide a method and process for combining and fusing modular neural networks, thus enabling various artificial-intelligence services to be easily created while reducing the development period for artificial-intelligence services and maximizing the reutilization of existing technologies.

Further, the present invention may greatly contribute to the construction of industrial ecosystems, such as enabling the implementation of a market environment in which value chains between basic neural network developers, various transform plugin developers, and application service developers are constructed.

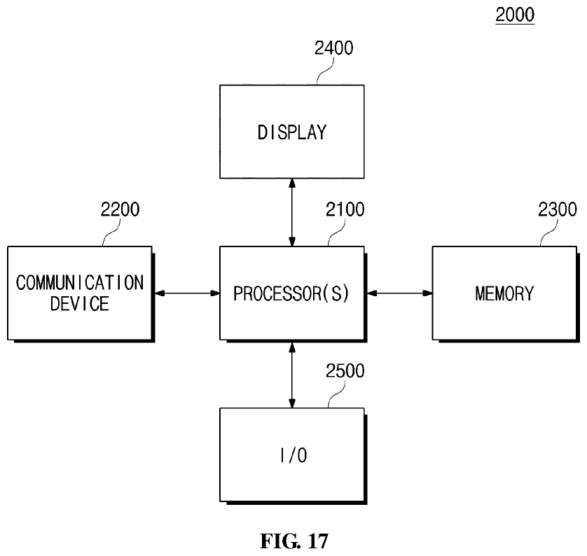

FIG. 17 is a diagram exemplarily illustrating an electronic device 2000 according to an embodiment of the present invention. Referring to FIG. 17, the electronic device 2000 may include at least one processor 2100, a network interface (communication device) 2200, memory 2300, a display 2400, and an input/output (I/O) device 2500.

The processor 2100 may include at least one of the apparatuses described above with reference to FIGS. 1 to 16, or may be implemented using at least one of the methods described above with reference to FIGS. 1 to 16. As described above, the processor 2100 may execute instructions so that a first neural network is generated by a modular neural network module and a second neural network is generated by the modular neural network module and so that the output data of the first neural network matches the input data of the second neural network.

The processor 2100 may execute a program and control the electronic device 2000. The electronic device 2000 may be connected to an external device (e.g. a personal computer or a network) through the input/output device 2500, and may exchange data therewith. The electronic device 2000 may include any of various electronic systems, for example, mobile devices, such as a mobile phone, a smart phone, a Personal Digital Assistant (PDA), a tablet computer, and a laptop computer, computing devices, such as a personal computer, a tablet computer, and a Netbook, or electronic appliances, such as a television, a smart television, and a security device for gate control.

The network interface 2200 may be implemented to perform communication with an external network in various wired/wireless manners.

The memory 2300 may include computer-readable instructions. The processor 2100 may perform the above-described operations when the instructions stored in the memory 2300 are executed on the processor 2100. The memory 2300 may be volatile memory or nonvolatile memory. The memory 2300 may include a storage device to store data of a user. The storage device may be an Embedded Multimedia Card (eMMC), a Solid-State Drive (SSD), universal flash storage (UFS), or the like. The storage device may include at least one nonvolatile memory device. The nonvolatile memory device may be any one of NAND flash memory, Vertical NAND (VNAND) flash memory, NOR flash memory, Resistive Random Access Memory (RRAM), Phase-Change Memory (PRAM), Magnetoresistive Random Access Memory (MRAM), Ferroelectric Random Access Memory (FRAM), and Spin Transfer Torque Random Access Memory (STT-RAM).

The above-described embodiments may be implemented using hardware components, software components, and/or combinations of hardware components and software components. For example, the apparatus (device), method, and components described above in the embodiments may be implemented using one or more general-purpose computers or special-purpose computers, as in the case of a processor, a controller, an Arithmetic Logic Unit (ALU), a digital signal processor, a microcomputer, a Field-Programmable Gate Array (FPGA), a Programmable Logic Unit (PLU), a microprocessor, or any other device capable of executing and responding to instructions. A processing device may execute an Operating System (OS) and one or more software applications running on the OS.

Further, the processing device may access, store, handle, process and generate data in response to the execution of software. For convenience of understanding, there is the case where a single processing device is described as being used, but those skilled in the art to which the corresponding technical fields pertain will understand that the processing device may include multiple processing elements and/or multiple types of processing elements. For example, the processing device may include multiple processors, or a single processor and a single controller. Furthermore, the processing device may include an additional processing configuration such as one including parallel processors.

The software may include a computer program, code, an instruction, or a combination of one or more thereof, and may configure the processing device so that the processing device is operated in a desired manner, or may independently or collectively issue commands to the processing device. The software and/or data may be interpreted by the processing device or may be permanently or temporarily embodied in a certain type of machine, a component, a physical device, virtual equipment, a computer-storage medium or device, or a signal wave to be transmitted so as to provide commands or data to the processing device. The software may be distributed to computer systems connected over a network, and may also be stored or executed in a distributed manner. The software and data may be stored in one or more computer-readable storage media.

The method according to the embodiment may be implemented in program instructions that can be executed through various types of computer means, and may be recorded in a computer-readable storage medium. The computer-readable storage medium may include a program instruction, a data file, a data structure, etc. alone or in combination. The program instruction recorded in the medium may be designed and configured especially for embodiments or may be known to and used by those skilled in computer software fields. Examples of the computer-readable storage medium may include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine code, such as code created by a compiler, and high-level language code executable by a computer using an interpreter. The hardware devices may be configured to operate as one or more software modules in order to perform the operation of the present invention, and vice versa.

The neural network fusion apparatus and the modular neural network fusion method and matching interface generation method for the neural network fusion apparatus according to embodiments of the present invention are advantageous in that, when a new artificial-intelligence service is implemented, the functions of modular neural networks, in which existing unit functions are configured, may be utilized.

The neural network fusion apparatus and the modular neural network fusion method and matching interface generation method for the neural network fusion apparatus according to embodiments of the present invention are advantageous in that modular neural networks having unit functions may be combined and fused, thus enabling various artificial-intelligence services to be easily created while reducing the development period for artificial-intelligence services and maximizing the reutilization of existing technologies.

The neural network fusion apparatus and the modular neural network fusion method and matching interface generation method for the neural network fusion apparatus according to embodiments of the present invention are advantageous in that they may greatly contribute to the construction of industrial ecosystems, such as enabling the implementation of a market environment in which value chains between basic neural network developers, various transform plugin developers, and application service developers are constructed.

Meanwhile, the above description of the present invention merely shows detailed embodiments for practicing the present invention. The present invention may include not only a detailed means that can be actually utilized, but also a technical spirit that is an abstract and conceptual idea and that can be used as technology in the future.

What is claimed is:

1. A modular neural network fusion method in a neural network fusion apparatus, comprising:
collecting meta-information of a first neural network and a second neural network;
connecting a matching module between the first neural network and the second neural network using the collected meta-information so that output data of the first neural network matches input data of the second neural network; and
executing a neural network interworking service for obtaining output data of the second neural network from input data of the first neural network through the first and second neural networks connected to each other via the matching module.

2. The modular neural network fusion method of claim 1, wherein the collecting the meta-information comprises:
reading information about a data type and format information of an output parameter from a meta-information storage of the first neural network; and
reading information about a data type and format information of an input parameter from a meta-information storage of the second neural network.

3. The modular neural network fusion method of claim 2, wherein the connecting the matching module comprises generating, by a matching interface generator, a matching interface corresponding to output parameters of the first neural network and input parameters of the second neural network.

4. The modular neural network fusion method of claim 3, wherein:
the matching interface comprises plurality of transform plugins, and
the connecting the matching module further comprises:
generating the plurality of transform plugins; and
connecting the plurality of transform plugins to each other.

5. The modular neural network fusion method of claim 3, wherein the matching interface generator determines whether generation of a matching interface is impossible.

6. The modular neural network fusion method of claim 3, wherein the executing the neural network interworking service comprises generating respective input interfaces and output interfaces of the first and second neural networks.

7. The modular neural network fusion method of claim 6, wherein the executing the neural network interworking service further comprises:
connecting the output interface of the first neural network to the matching interface; and
connecting the matching interface to the input interface of the second neural network.

8. The modular neural network fusion method of claim 6, wherein the executing the neural network interworking service further comprises setting activation functions contained in the input interfaces and the output interfaces of the first and second neural networks.

9. The modular neural network fusion method of claim 1, wherein:
the first neural network is a speech recognition neural network, and
the second neural network is an image recognition neural network.

10. A method for generating a matching interface connecting a first neural network and a second neural network in a neural network fusion apparatus, comprising:
initializing an input format of the first neural network and an output format of the second neural network;
determining whether the first neural network and the second neural network are capable of being connected to each other without requiring transform plugins by comparing the input format with the output format;
upon determining that the first neural network and the second neural network are not capable of being connected to each other without requiring transform plugins, determining whether there are matchable transform plugins respectively corresponding to the input format and the output format; and
upon determining that there are matchable transform plugins, generating a matching interface for connecting the first neural network to the second neural network by combining the matchable transform plugins.

11. The method of claim 10, wherein the initializing the input format of the first neural network and the output format of the second neural network comprises:
storing, as the input format, a data type of an output parameter stored in a meta-information storage of the first neural network; and
storing, as the output format, a data type of an input parameter stored in a meta-information storage of the second neural network.

12. The method of claim 11, wherein the initializing the input format of the first neural network and the output format of the second neural network further comprises:
storing, as the input format, a data format of reference information stored in the meta-information storage of the first neural network; and
storing, as the output format, a data format of reference information stored in the meta-information storage of the second neural network.

13. The method of claim 11, wherein the determining whether the first neural network and the second neural network are capable of being connected to each other comprises determining whether the data type of the output parameter and the data type of the input parameter are identical to each other by comparing the data types with each other.

14. The method of claim 11, wherein the determining whether there are matchable transform plugins further comprises searching for transform plugins having a data type identical to that of the input format and the output format.

15. The method of claim 11, wherein the generating the matching interface comprises:
storing first transform plugins having a data type identical to that of the input format; and
storing second transform plugins having a data type identical to that of the output format.

16. The method of claim 15, wherein the generating the matching interface further comprises generating a matchable combination by comparing elements of the input format with respective elements of the output format.

17. The method of claim 15, wherein the generating the matching interface further comprises determining whether the first transform plugins and the second transform plugins are capable of being combined with each other.

18. A neural network fusion apparatus, comprising:
at least one processor; and
a memory for storing at least one instruction that is executed by the at least one processor,
wherein the at least one instruction is executed by the at least one processor so that:
a first neural network is generated by a modular neural network module,
a second neural network is generated by the modular neural network module, and
output data of the first neural network matches input data of the second neural network through a matching interface.

19. The neural network fusion apparatus of claim 18, wherein:
the first neural network receives image data and outputs a text file, and
the second neural network receives the text file and outputs an audio file.

20. The neural network fusion apparatus of claim 18, wherein:
the first neural network is a speech recognition neural network,
the second neural network is an image recognition neural network, and
the first neural network and the second neural network are fused through the matching interface, thus enabling a context-aware neural network to be implemented.
